(19) United States
(12) Patent Application Publication
(10) Pub. No.: US 2026/0292220 A1
(43) Pub. Date: Sep. 24, 2026

(54) METHODS AND APPARATUS OF USING SELF-DERIVED CROSS-COMPONENT MODELS FOR VIDEO CODING IMPROVEMENT OF INTER CHROMA

(71) Applicant: MEDIATEK INC., Hsinchu City (TW)

(72) Inventors: Hsin-Yi TSENG, Hsinchu City (TW); Man-Shu CHIANG, Hsinchu City (TW); Chia-Ming TSAI, Hsinchu City (TW); Chih-Wei HSU, Hsinchu City (TW)

(21) Appl. No.: 19/472,756

(22) PCT Filed: Oct. 18, 2024
(86) PCT No.: PCT/CN2024/125890

§ 371 Date: Oct. 6, 2025

Related U.S. Application Data
(60) Provisional application No. 63/591,471, filed on Oct. 19, 2023.

(51) Int. Cl. H04N 19/186; H04N 19/105; H04N 19/117; H04N 19/172; H04N 19/176; H04N 19/189; H04N 19/503; H04N 19/70

(52) U.S. Cl. CPC H04N 19/186; H04N 19/105; H04N 19/117; H04N 19/172; H04N 19/176; H04N 19/189; H04N 19/503; H04N 19/70

(57) ABSTRACT

A method and apparatus for cross-component prediction are disclosed. According to this method, if self-derived cross-component prediction is applied to the current block, explicit signalling is applied or implicit rules are used to determine a type of the self-derived cross-component prediction, models of the self-derived cross-component prediction, or both. Self-derived cross-component prediction target models are determined based on the type of the self-derived cross-component prediction, the models of the self-derived cross-component prediction, or both. The current second-colour block is encoded or decoded by using the self-derived cross-component prediction target models to code the current second-colour block, wherein prediction data for the current second-colour block is generated by applying cross-component target models to the current first-colour block.

### CROSS REFERENCE TO RELATED APPLICATIONS

The present invention is a non-Provisional Application of and claims priority to U.S. Provisional Patent Application No. 63/591,471, filed on Oct. 19, 2023. The U.S. Provisional Patent Application is hereby incorporated by reference in its entirety.

### FIELD OF THE INVENTION

The present invention relates to video coding system using coding tools including one or more cross component models related modes. In particular, the present invention relates to coding for a chroma component using self-derived cross-component prediction candidates based on the type of the self-derived cross-component prediction, models of the self-derived cross-component prediction, or both.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search.

Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i, j) represents the predicted chroma samples in a CU and rec_{L}′(i, j) represents the downsampled reconstructed luma samples of the same CU.

The CCLM parameters (a and B) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied.

In this disclosure, the term {LM_LA, LM_A, LM_L} and {CCLM_LT, CCLM_T, CCLM_L} are used interchangeably.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular a and B are derived for a particular group). Furthermore, the samples of the current luma block are also classified based on the same rule for the classification of neighbouring luma samples.

Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 2 )$$

In this disclosure, the term {MMLM_LA, MMLM_A} and {MMLM_LT, MMLM_T} are used interchangeably.

### Convolutional Cross-Component Model (CCCM)

In CCCM, a convolutional model is applied to improve the chroma prediction performance. The convolutional model has 7-tap filter consisting of a 5-tap plus sign shape spatial component, a nonlinear term and a bias term.

Output of the filter is calculated as a convolution between the filter coefficients and the input values and clipped to the range of valid chroma samples.

The filter coefficients are calculated by minimising MSE between predicted and reconstructed chroma samples in the reference area.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged:

$$C = α \cdot G + β .$$

FIG. 2 shows the 16 gradient filters (210-240) for the gradient calculation.

### Intra Block Copy

Intra block copy (IBC) is a tool adopted in HEVC extensions on screen content coding (SCC). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

### CCCM Using Non-Down-Sampled Luma Samples

CCCM mode with 3×2 filter using non-down-sampled luma samples is used, which consists of 6-tap spatial terms, four nonlinear terms and a bias term. The 6-tap spatial terms correspond to 6 neighbouring luma samples (i.e., L0, L1, . . . , L5) around the chroma sample (i.e., C) to be predicted, the four non-linear terms are derived from the samples L0, L1, L2, and L3 as shown as follows, where the locations of the non-down-sampled luma samples are shown in FIG. 3.

$$C = {\sum }_{i = 0}^{5} {α}_{i} \cdot ( {L}_{i} - offsetLuma ) + {\sum }_{i = 6}^{9} {α}_{i} \cdot ( ( {( {L}_{i - 4} - offsetLuma )}^{2} + β ) ≫ bitDepth ) + {α}_{10} \cdot β + offsetChroma$$

### Cross-Component Residual Model (CCRM)

As in JVET-AD0108 (Pekka Astola, et. al., “AHG12: Cross-component residual model (CCRM) for inter prediction”, Joint Video Experts Team (JVET) of ITU-T SG 16 WP 3 and ISO/IEC JTC 1/SC 29, 30th Meeting, Antalya, TR, 21-28 Apr. 2023, Document: JVET-AD0108), it is to apply cross-component residual model (CCRM) to predict chroma samples from reconstructed luma samples when the block uses inter prediction or intra block copy (IBC). FIG. 4 illustrates the decoder side of the method. The cross-component filters are derived using the prediction signals of luma and chroma. The derived filters are applied to the reconstructed luma signal producing the final chroma predictions. Filter coefficients are derived in step 420 for each chroma component separately using the prediction signals (i.e., predY 410, and predCb 412 or predCr 414) and the filters are applied to the reconstructed luma signal in step 430 as shown in FIG. 4. The reconstructed luma signal is formed by combining the luma prediction (PredY) 410 and residual luma signal (resY) using an adder 422. After applying the filters, the step 430 generates filtered-predicted Cb 440 and filtered-predicted Cr 450. The reconstructed Cb signal is formed by combining the filtered-predicted Cb 440 and residual Cb signal (i.e., resCb) using an adder 442. Similarly, the reconstructed Cr signal is formed by combining the filtered-predicted Cr 450 and residual Cr signal (i.e., resCr) using an adder 452.

The proposed 8-tap filter consist of 6 spatial luma samples, a nonlinear term, and a bias term. The spatial luma samples (L0, . . . , L5) are obtained from the luma grid selecting the 6 luma samples closest to the chroma position C without down sampling as shown in FIG. 5. The predicted chroma value is obtained as,

$$predChromaVal = {c}_{0} L 0 + {c}_{1} L 1 + {c}_{2} L 2 + {c}_{3} L 3 + {c}_{4} L 4 + {c}_{5} L 5 + {c}_{6} nonlinear ( ( L 0 + L 3 + 1 ) ≫ 1 ) + {c}_{7} B ,$$

where nonlinear is CCCM's nonlinear operator and B is bias.

The filter coefficients are derived using ECM's division-free Gaussian elimination method and the necessary offsets are applied to samples prior to filter derivation.

Intra reference samples are used as additional input samples in filter derivation when the block has less than 64 chroma samples. CCCM's design of at most 6 rows and columns of intra reference samples is used.

### Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side. 25

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

### Spatial Candidate Derivation

The derivation of spatial merge candidates in VVC is the same as that in HEVC except that the positions of first two merge candidates are swapped. A maximum of four merge candidates (B₀, A₀, B₁ and A₁) for current CU 610 are selected among candidates located in the positions depicted in FIG. 6. The order of derivation is B₀, A₀, B₁, A₁ and B₂. Position B₂ is considered only when one or more neighbouring CU of positions B₀, A₀, B₁, A₁ are not available (e.g. belonging to another slice or tile) or is intra coded. After candidate at position A₀ is added, the addition of the remaining candidates is subject to a redundancy check which ensures that candidates with the same motion information are excluded from the list so that coding efficiency is improved.

In addition to the above-mentioned spatial candidates, the non-adjacent spatial merge candidates as in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399) are inserted after the TMVP in the regular merge candidate list. An example of the pattern of spatial merge candidates is shown in FIG. 7. The distances between non-adjacent spatial candidates and current coding block are based on the width and height of current coding block. The line buffer restriction is not applied.

### Temporal Candidates Derivation

In this step, only one candidate is added to the list. Particularly, in the derivation of this temporal merge candidate for a current CU 810, a scaled motion vector is derived based on the co-located CU 820 belonging to the collocated reference picture as shown in FIG. 8. The reference picture list and the reference index to be used for the derivation of the co-located CU is explicitly signalled in the slice header. The scaled motion vector 830 for the temporal merge candidate is obtained as illustrated by the dotted line in FIG. 8, which is scaled from the motion vector 840 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

In order to improve the coding performance for a system using cross-component models, methods and apparatus of using self-derived cross-component prediction candidates based on the type of the self-derived cross-component prediction, models of the self-derived cross-component prediction, or both are disclosed.

### BRIEF SUMMARY OF THE INVENTION

A method and apparatus for coding colour pictures or video using coding tools including one or more cross component models related modes are disclosed. According to this method, input data associated with a current block comprising a current first-colour block and a current second-colour block is received, wherein the input data comprise pixel data to be encoded at an encoder side or data associated with the current block to be decoded at a decoder side, and wherein the current block is coded in a non-intra mode. If self-derived cross-component prediction is applied to the current block, explicit signalling is applied or one or more first implicit rules are used to determine a type of the self-derived cross-component prediction, one or more models of the self-derived cross-component prediction, or both. One or more self-derived cross-component prediction target models are determined based on the type of the self-derived cross-component prediction, said one or more models of the self-derived cross-component prediction, or both. The current second-colour block is encoded or decoded by using said one or more self-derived cross-component prediction target models, wherein prediction data for the current second-colour block is generated by applying cross-component target models to the current first-colour block.

In one embodiment, for the type of the self-derived cross-component prediction, said one or more models of the self-derived cross-component prediction are identified. In one embodiment, said one or more models of the self-derived cross-component prediction are identified according to one or more second implicit rules, or according to explicit signalling at a block level, CU level, SPS level, PPS level, picture level, slice level, tile level, sequence level, CTU level, or a combination thereof.

In one embodiment, said one or more self-derived cross-component prediction target models are used to generate one or more hypotheses of cross-component prediction and a cross-component predictor is generated based on said one or more hypotheses of cross-component prediction.

In one embodiment, after the type of the self-derived cross-component prediction is determined, said one or more self-derived cross-component prediction target models are selected from said one or more models of the self-derived cross-component prediction.

In one embodiment, one type of the self-derived cross-component prediction refers to deriving said one or more models of the self-derived cross-component prediction based on input reference samples including only neighbouring samples of the current block, neighbouring samples of a collocated luma block of the current block, or both. In one embodiment, samples within the current block, the collocated luma block of the current block, or both are not referenced. In one embodiment, the input reference samples include only neighbouring samples of the current block, the neighbouring samples of the collocated luma block of the current block, or both with one or more exceptions. In one embodiment, type of self-derived cross-component prediction selected corresponds to using input reference samples only or mainly from neighbouring regions of the current block, from neighbouring regions of the collocated luma block of the current block, or both. In one embodiment, said one or more models of the self-derived cross-component prediction have filtering terms the same as some intra cross-component models, and wherein the filtering terms are derived only or mainly using the input reference samples from neighbouring regions of the current block, from neighbouring regions of the collocated luma block of the current block, or both.

In one embodiment, one type of the self-derived cross-component prediction refers to deriving said one or more models of the self-derived cross-component prediction based on input reference samples including only samples within the current block, a collocated luma block of the current block, or both, including only samples within the current block, the collocated luma block of the current block, or both with one or more exceptions. In one embodiment, type of self-derived cross-component prediction selected corresponds to using input reference samples only or mainly within the current block, a collocated luma block of the current block, or both. In one embodiment, said one or more models of the self-derived cross-component prediction have filtering terms the same as some intra cross-component models, and wherein the filtering terms are derived only or mainly using the input reference samples within the current block, the collocated luma block of the current block, or both. In one embodiment, said one or more models of the self-derived cross-component prediction comprise CCRM (Cross-Component Residual Model).

In one embodiment, a flag is signalled or parsed to indicate the type of the self-derived cross-component prediction.

In one embodiment, for the type of the self-derived cross-component prediction determined, if multiple models of the self-derived cross-component prediction are defined, the multiple models of the self-derived cross-component prediction are inserted into a candidate list following a pre-defined order and the candidate list includes only self-derived models, or one or more models are selected from the multiple models of the self-derived cross-component prediction as said one or more self-derived cross-component prediction target models according to a pre-defined rule. In one embodiment, a size of the candidate list is pre-defined as any positive integer or adaptively decided according to availability of the multiple models of the self-derived cross-component prediction. In one embodiment, availability of single-model CCCM and multi-model CCCM candidate models are dependent on model parameters or scaling parameters of single-model CCCM.

In one embodiment, the pre-defined rule corresponds to implicitly selecting said one or more models as said one or more self-derived cross-component prediction target models from the candidate list, or the pre-defined rule corresponds to signalling one or more explicit indices to select said one or more models as said one or more self-derived cross-component prediction target models from the candidate list. In one embodiment, a cost is calculated for each candidate model in the candidate list and one or more candidate models with smallest costs in the candidate list are selected.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows 16 gradient patterns for GLM.

FIG. 3 illustrates the 6-tap spatial terms corresponding to 6 neighbouring luma samples (i.e., L0, L1, . . . , L5) around the chroma sample (i.e., C) to be predicted for CCCM mode.

FIG. 4 shows an exemplary system block diagram for Cross-component residual model (CCRM).

FIG. 5 illustrates the luma samples L0, . . . , L5 in relation to the chroma sample C.

FIG. 6 illustrates the 5 neighbouring blocks used for deriving spatial merge candidates for VVC.

FIG. 7 illustrates an exemplary pattern of the adjacent and non-adjacent spatial merge candidates.

FIG. 8 illustrates an example of temporal candidate derivation, where a scaled motion vector is derived according to POC (Picture Order Count) distances.

FIG. 9 illustrates an example of signalling or parsing a type flag when the current block uses re-derived CCP mode according to one embodiment of the present invention.

FIG. 10A-FIG. 10B illustrate the patterns of the n taps in a window region M×N around/including the position (iL, jL) to derive the sourceTermSet0(i, j), where only the centre is used (FIG. 10A) and a 5×5 cross is used (FIG. 10B).

FIG. 11 illustrates an example of using Sobel filters to derive the gradient information from the predicted samples and/or reconstructed samples of the source.

FIG. 12A-FIG. 12B illustrate the patterns of the m taps in a window region M2×N2 around/including the position (iC, jC) to derive the sourceTermSet1(i, j), where only the centre is used (FIG. 12A) and a 5×5 cross is used (FIG. 12B).

FIG. 13 illustrates an example of neighbouring spatial regions used as reference regions for weighting setting for self-derived cross-component model.

FIG. 14 illustrates a flowchart of an exemplary video coding system that uses self-derived cross-component prediction candidates based on the type of the self-derived cross-component prediction, models of the self-derived cross-component prediction, or both according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the coding performance of cross-component prediction, methods and apparatus using self-derived cross-component prediction candidates based on the type of the self-derived cross-component prediction, models of the self-derived cross-component prediction, or both are disclosed.

The cross-component information is used to improve prediction accuracy of an inter block. To improve the prediction accuracy of the chroma component of the inter block, the luma information from the corresponding luma component of the current chroma block, and/or the chroma information from the current chroma block, and/or the chroma information from the previous coded chroma component are used.

The first scheme is that for a coding unit (under single tree splitting) including luma (Y) and chroma (Cb and/or Cr) components, the prediction for Cb and/or Cr is improved by applying the cross-component models to information (current reconstructed or predicted) from Y.

The second scheme is that for a coding unit (under single tree splitting) including luma (Y) and chroma (Cb and/or Cr) components or for a coding unit (under chroma dual tree splitting) including chroma (Cb and/or Cr) components, the prediction for Cr is improved by applying the cross-component models to information (current reconstructed or predicted) from Cb.

In the following, several embodiments related to the first scheme are proposed to use an inherited cross-component mode for the current chroma block with the following steps: Step (1) building a candidate list (modelList) for the current block where the candidate list includes cross-component models; Step (2) selecting one or more sets of model information in the list; and Step (3) using the model information (similar to intra chroma cross-component mode) to generate one or more hypotheses of predictions for the current chroma component (Cb or Cr) by applying and/or modifying the selected model information to the reconstructed or predicted samples for the corresponding luma component.

When the selected model information refers to traditional cross-component linear model(s), the proposed method is called as inter cross-component linear model (inter CCLM) mode. When the selected model information refers to convolutional cross-component model(s) (CCCM) derived by a regression-based method (e.g. CCCM), the proposed method is called as inter cross-component convolution model (inter CCCM) mode.

Moreover, in some embodiments, a self-derived (a.k.a. re-derived) cross-component mode is proposed and can be added into the candidate list in Step (1). In some embodiments, the self-derived cross-component mode is not added into the list and a selection of using the proposed inherited mode and/or using the proposed self-derived mode is designed. In some embodiments, the selection of using the proposed inherited mode and/or using the proposed self-derived mode is determined following an explicit rule, an implicit rule, or both. More details are described in the section entitled “IV. Selection of Using the Proposed Inherited Mode and/or Using the Proposed Self-Derived Mode”. In this disclosure, the term “self-derived” and “re-derived” are used interchangeably.

In one embodiment, the proposed embodiments can also be used for the second scheme by using the previous coded chroma component (Cb) as the luma component in the first scheme.

### Storage and Inheritance of the Model

In another embodiment, when the current inter block uses the model parameters from the self-derived cross-component mode, the used model parameters can be saved and/or referenced by the following coding blocks. For an example of the self-derived cross-component being CCRM, all or any subset of the model parameters can be saved. In one embodiment, if the following coding block is intra, it is allowed to use the saved model parameters. If the following coding block is inter or any mode-type (e.g., IBC), it is allowed to use the saved model parameters. In another embodiment, if the following coding block and the current block have different mode-types (e.g., one being an inter block and one being not an inter block), it is not allowed to use the saved model parameters.

In another embodiment, when the current inter block uses the inherited cross-component mode, the used model parameters can be saved and/or referenced by the following coding blocks. For an example of the inherited CCCM, all or any subset of the model parameters can be saved. In one embodiment, if the following coding block is intra, it is allowed to use the saved model parameters. If the following coding block is inter or any mode-type (e.g. IBC), it is allowed to use the saved model parameters. In another embodiment, if the following coding block has different mode-type (e.g., not an inter block), it is not allowed to use the saved model parameters.

In another embodiment, when the current inter block uses any cross-component models (e.g. the inherited cross-component model, the self-derived cross-component model, cross-component model used in chroma fusion which means the chroma prediction is based on adding one or more hypotheses of cross-component prediction to one or more existing hypotheses of prediction of non-cross-component prediction, or any combination of the above), the used model parameters can be saved and/or referenced by the following coding blocks. For an example of the inherited CCCM, all or any subset of the model parameters can be saved. In one embodiment, if the following coding block is intra, it is allowed to use the saved model parameters. If the following coding block is inter or any mode-type (e.g. IBC), it is allowed to use the saved model parameters. In another embodiment, if the following coding block has a different mode-type (e.g., not an inter block), it is not allowed to use the saved model parameters.

### I. Building a Candidate List Including Cross-Component Models

In one embodiment, when building the merge-like candidate model list (modelList), one or more sets of the following candidate model information are included. For each candidate in the list, it refers to a candidate model information. The definition of the model information can be found in the section entitled: “V.1. Inheriting CCM Information”.
Spatial model information from spatial neighbour blocks (corresponding to “Spatial MVP from spatial neighbour CUs” for inter)
Temporal model information from collocated blocks (corresponding to “Temporal MVP from collocated CUs” for inter)
History-based model information from a FIFO table (corresponding to “History-based MVP from a FIFO table” for inter)
Pairwise average model information (corresponding to “Pairwise average MVP” for inter)
Default model information (corresponding to “Zero MVs” for inter)

In one sub-embodiment of the candidate type being “spatial model information from spatial neighbour blocks” in the above candidate type list, a valid spatial neighbouring block(s) can be from one of spatial adjacent and non-adjacent neighbours (or any subset of the blocks in a neighbouring search region for the current block) which satisfies a pre-defined condition. For an example of non-adjacent neighbours, the pre-defined condition (e.g., valid/available checking) refers that the non-adjacent neighbour is in the available region of non-adjacent spatial candidates. For example, the pre-defined condition is that the neighbour is coded by a cross-component mode or combining with cross-component mode. The cross-component mode refers to modes such as CCLM, MMLM, CCCM, GLM, the mode with mode information inherited from a merge-like candidate list, MH CCLM, and/or any cross-component mode with syntax belonging cross-component branch (containing many cross-component modes) and not belonging to tradition intra prediction modes). Combining with cross-component mode refers to modes such as chroma fusion (or named LM assisted Angular/Planar Mode), inter CCLM, inter CCCM and/or any traditional mode with syntax not belonging to cross-component branch, but using the cross-component information to generate the prediction. In another sub-embodiment, when checking the validation of a neighbouring coding block, a second-round valid checking is further used when the mentioned valid checking (e.g., neighbouring block not being cross-component mode or neighbouring block not using/combining cross-component mode), the motion vectors and/or block vectors of the neighbouring block can be used to find the cross-component models. Variations of how to use motion vector and/or block vectors to find the model can reference the description of “Temporal model information from collocated blocks” in the above candidate type list. If the model is found, the second-round valid checking for the neighbouring block is satisfied and the found models can be inserted in the list; otherwise, the neighbouring block is not valid for inserting. When scanning the spatial neighbouring blocks, a candidate is added into the list if the candidate is valid.

In another sub-embodiment of the candidate type being “Temporal model information from collocated blocks”, in the first case, the collocated block is from the block in the reference picture or the pre-defined collocated picture as inter mode by using the current block position and/or the current block motion, and/or in the second case, the collocated block is from the block in the reference picture or the pre-defined collocated picture as inter mode by using the current block position and/or the neighbouring block motion. In the first case, for example, when the current block is coded by inter prediction mode, the collocated block is referred by the motion information (including the motion vectors and the reference picture indicated by the reference index) of the current block. If the current block is a subblock motion mode (e.g., affine mode), each subblock in the current block has its own collocated temporal model information. Collocated temporal model information from all or any subset of collocated temporal information that are referred by the different subblock motions (of each subblock) is added into the list. For another example, when the reference picture indicated by the reference index is different from the pre-defined collocated picture, which can be the collocated picture used for temporal motion vector prediction in inter mode or any collocated picture specified in any video coding standard to keep the motion or cross-component model information stored and available for the current block, the temporal information from the reference picture is forbidden to be used. For another example, when the reference picture indicated by the reference index is different from the pre-defined collocated picture, which can be the collocated picture used for temporal motion vector prediction in inter mode or any collocated picture specified in any video coding standard to keep the motion or cross-component model information stored and available for the current block, the motion vector is scaled to refer the pre-defined collocated picture and the scaled motion vector is used to find the collocated block in the collocated picture to get the cross-component model in the collocated block. The scaling process is shown in the section of “Temporal Candidates Derivation”. Some examples are described for the second case. For one example, the temporal model information can be from the collocated block referred by the motion information of the neighbouring blocks for the current block. Similar to the first case, the forbidden method or the scaling method can be used in the second case. If the proposed methods are applied to an IBC block or any mode using block vectors (in the first case, the current block being IBC; in the second case, the neighbouring block being IBC), block vector information is used as motion vector where the block vector information is determined by signalling and/or template matching in a pre-defined searching range like intraTMP and/or any implicit or explicit pre-defined rules.

In another sub-embodiment of the candidate type being “History-based model information”, a history-based table (the FIFO table) is built and stores the model information from the previous coded blocks. The table can be reset as the beginning and/or the end of a CTU, slice, picture, tile, and/or sequence. One or more history-based candidates can be added into the candidate list by the order from the head to tail of the table or from the tail to head of the table.

In another sub-embodiment of the candidate type being “Pairwise average model information”, the model information of this candidate is derived based on the model information from more than one of the previous candidates in the list. For example, it can average and/or modify the model parameters of more than one candidate as the to-be-applied model parameters. For another example, it can combine more than one prediction as the final prediction, where each of more than one prediction is generated by applying one of models in the candidate list.

In another sub-embodiment, the default model information is added if the list is not full after inserting all pre-defined candidates. For example, the default model can be CCLM models. The default alpha (or named as α, a, or scaling parameters) are selected from {0, ⅛, −⅛, 2/8, − 2/8, ⅜, −⅜, . . . }, and the beta (or named as β, b, or offset parameter) is based on the selected default alpha, average neighbouring reconstructed luma sample value, and average neighbouring reconstructed chroma (Cb/Cr) sample value.

In another embodiment, when building modelList, one or more self-derived cross-component candidates are included. The self-derived cross-component candidates are described in the section entitled “Self-derived Cross-Component Model”. In another sub-embodiment, the self-derived cross-component candidates are added only when the list does not contain enough inherited candidates. For example, the self-derived candidates are added before the default candidates or treated as the default candidates. In another sub-embodiment, the self-derived cross-component candidates are added in any pre-defined position in the modelList. For example, the position is after the spatial adjacent candidates. For another example, the position is after the spatial non-adjacent candidates. For another example, the position is at the front of the modelList. For another example, the position is after all or any subset of temporal candidates.

After building the list, in one embodiment, the list is reordered as the methods defined in the section “Reordering the Candidates in the List.”

### II. Signalling of Enabling or Disabling and Selecting One or More Model Information in the List if Enabled

In this section, the term “inter CCLM” refers to “inter CCLM or inter CCCM”.

When not applying the proposed inter CCLM (or inter CCCM), the prediction of the current block is from the original inter prediction.

In another embodiment, the choice between applying inter CCLM or not applying inter CCLM depends on signalling.

In another sub-embodiment, when the signalling indicates to apply inter CCLM (or inter CCCM), additional signalling is used to select one or more models from total candidates. The candidate index is referred as modelIdx in this disclosure. If the modelList containing total candidates (e.g., candidates as described in the section entitled “Building a Candidate List Including Cross-Component Models”, CCLM_LT, CCLM_L, CCLM_T, MMLM_LT, MMLM_L, MMLM_T), or any subset of candidates are reordered by the methods in the section “Reordering the candidates in the list”, the additional signalling specifies the candidate index in the reordered list. For example, if one LM mode is selected, the LM prediction is generated by the selected one LM. For another example, if more than one LM modes are selected the LM prediction is generated by blending hypotheses of predictions from multiple LM modes.

In another sub-embodiment, the additional signal is not required and the one or more models are selected according to an implicit rule. For example, the first candidate in the list is used. If the list is reordered by the template cost, then, the first candidate is the candidate with the smallest template cost.

In another embodiment, original inter prediction (generated by motion compensation) is used for luma and the predictions of chroma components are generated by CCLM and/or any other LM modes.

In another embodiment, the one or more LM modes (i.e., cross-component modes) which will be used to generate the one or more hypotheses of predictions for LM assisted Angular/Planar Mode/inter CCLM/inter CCCM/MH CCLM are selected from a pre-defined merging candidate list (i.e., modelList). One modelIdx is signalled to select a candidate from the candidate list (modelList) and the selected candidate is used for the current block. The modelList contains one or more candidates where each candidate refers to a model (or cross-component mode) information. If only one candidate is in the list (i.e., the size of the list being 1), the modelIdx is not signalled and/or can be inferred as 0 or a default value. In one embodiment, the modelIdx is implicitly determined or the one or more models used for the current block are determined without signalling modelIdx. For example, the first candidate in the list is used. If the list is reordered by the template cost, the first candidate is the candidate with the smallest template cost. For another example, the used candidate/model is implicitly selected from the list by using a pre-defined rule depending on the coding information of the block for the to-be-used candidate. This embodiment is denoted as “noteA”.

The above proposed methods can be also applied to IBC blocks or the blocks with any IBC sub-modes (e.g., IBC merge or IBC AMVP or any IBC mode under IBC syntax). The term “inter” in this invention can be changed to IBC. That is, for chroma components, the block vector prediction can be combined or replaced with cross-component prediction.

### III. Using the Model Information to Generate One or More Hypotheses of Predictions for the Current Chroma Component

### III.1. Concept

In one embodiment, prediction or reconstruction-based model is used to generate one hypothesis of prediction for the current chroma component.

In one sub-embodiment of a prediction based linear model, the derived model parameters are applied to the predicted samples for the first component (Y) to get the predicted samples for the second or third component.

$$P ( i , j ) = a \cdot {pred}_{L}^{′} ( i , j ) + b$$

The predicted samples for the first component are down-sampled with the downsampling filters, which may be fixed at one-predefined filter or selected among some candidate filters.

In another sub-embodiment of a reconstruction based linear model, the derived model parameters are applied to the reconstructed samples for the first component (Y) to get the predicted samples for the second or third component.

$$P ( i , j ) = a \cdot {reco}_{L}^{′} ( i , j ) + b$$

The reconstructed samples for the first component are down-sampled with the downsampling filters, which may be fixed at one-predefined filter or selected among some candidate filters.

Prediction or reconstruction based convolution model is similar to the proposed methods for the prediction or reconstruction based linear model. The main difference is that the model coefficient pattern follows CCCM (not CCLM) and the luma samples may or may not be down-sampled first.

In another embodiment, multiple hypotheses (MH) of cross-component predictions are blended or multiple models are used to generate a hypothesis of prediction for the current block. Multiple-hypothesis CCLM is proposed to blend the predictions from multiple CCLM methods. The term “CCLM methods” can refer all the cross-component modes. The to-be-blended CCLM methods can be from (but are not limited to) the above mentioned CCLM methods (e.g., CCLM, MMLM, CCCM, GLM, CCRM, . . . ) and/or models defined in the embodiment described in noteA. A weighting scheme is used for blending.

### III.2. CCLM for Inter Block

The term “CCLM for inter block” can also be named as “inter CCLM” and “CCLM” can be extended to any LM mode (or any cross-component mode) or replaced with any LM mode (or any cross-component mode). When convolutional cross-component models derived by a regression based method is used, CCLM for inter block can also be named as inter CCCM.

In one embodiment, for chroma components, in addition to original inter prediction (generated by motion compensation which can be uni-prediction and/or bi-prediction, multiple hypotheses of prediction from multiple motion candidates which may refer to one or more merge candidates, one or more AMVP candidates, any combination of above, or which can be only uni-prediction), one or more hypotheses of predictions (generated by CCLM and/or any other LM modes, CIIP, regular inter merge mode, GPM or GPM variations) are used to generate the current prediction.

In one sub-embodiment, the current prediction is the weighted sum of inter prediction and CCLM prediction.

In another embodiment, inter CCLM is supported only when one or more of the pre-defined inter modes are used for the current block, or inter CCLM is supported when any one (or more than one) of the enabling flag(s) of the pre-defined inter mode is (are) indicated as enabled. The meaning of supporting inter CCLM is that the prediction of the current block can be chosen between applying inter CCLM or not applying inter CCLM.

For another example, if CCLM mode is used for generating the chroma prediction samples and luma prediction is from an inter coding tool, a flag is used to indicate if the CCLM model used for the chroma prediction is inherited from the CCLM models used in the previous coded blocks or the CCLM model is from a predetermined CCLM mode. If the CCLM model is inherited from the CCLM models used in the previous coded blocks, an index is used to indicate which model in the list is inherited or modified. Otherwise, a predetermined CCLM mode is used to implicitly derive the CCLM model for the current chroma prediction.

IV. Selection of Using the Proposed Inherited Mode and/or Using the Proposed Self-Derived Mode

In one embodiment, a flag can be signalled to indicate/select if the re-derived model is used. If the flag is 0, the cross-component model used to encode the neighbour merge candidate is inherited. If the flag is 1, the re-derived method is used.

In another embodiment, if the re-derived method is determined to be used, additional syntax elements (e.g., one additional flag) and/or some implicit rules are used to decide the type of the re-derived method and/or the one or more models of the re-derived method.
One candidate type of the re-derived method may correspond to that the input reference samples (of the model derivation process for the re-derived method) are located only at the neighbouring samples of the current block and/or the neighbouring samples of the collocated luma block of the current block without referencing the sample information within the current block and/or the sample information within the collocated luma block of the current block. In other words, the input reference samples only include neighbouring samples of the current block and/or of the collocated luma block of the current block.
Another candidate type of the re-derived method may correspond to that the input reference samples (of the model derivation process for the re-derived method) are located only within the current block and/or the sample information within the collocated luma block of the current block.
Another candidate type of the re-derived method may correspond to that the input reference samples (of the model derivation process for the re-derived method) include only samples within the current block and/or within the collocated luma block of the current block with some exceptions (i.e., the input reference samples (of the model derivation process for the re-derived method) are located mainly within the current block and/or the collocated luma block of the current block). Only in some special cases (i.e., being those exceptions), the input reference samples (of the model derivation process for the re-derived method) will include the neighbouring samples of the current block and/or the neighbouring samples of the collocated luma block of the current block. The special case may refer to the width, height, and/or area of the current block being smaller than a pre-defined threshold. In other words, if the width, height, and/or area of the current block is smaller than a pre-defined threshold, the neighbouring samples of the current block and/or of the collocated luma block of the current block will be included. The special case may refer to down-sampled luma at the boundary of the collocated luma block of the current block. In other words, the down-sampled luma samples at the outer boundary of the collocated luma block of the current block will be included.
Another candidate type of the re-derived method is that the input reference samples (of the model derivation process for the re-derived method) only include the neighbouring samples of the current block and/or of the collocated luma block of the current block with some exceptions (i.e., the input reference samples (of the model derivation process for the re-derived method) are located mainly at the neighbouring samples of the current block and/or the neighbouring samples of the collocated luma block of the current block). Only in some special cases (i.e., being those exceptions), the input reference samples (of the model derivation process for the re-derived method) will include the samples within the current block and/or the collocated luma block of the current block. The special case may refer to the position, width, height, and/or area of the current block. In other words, if the width, height, and/or area of the current block is smaller than a pre-defined threshold, the sample within the current block and/or within the collocated luma block of the current block are included. The special case may be that the position of the current block causes the current block to not have enough available reference samples at the neighbouring region of the current block and/or the neighbouring region of the collocated luma block of the current block. That is, if not enough reference samples in the neighbouring region can be obtained due to the position of the current block (e.g., the x-position, y-position, or the distance to (0,0) of the current block is smaller than a threshold), the sample within the current block and/or within the collocated luma block of the current block are included. The special case may refer to down-sampled luma at the boundary of the collocated luma block of the current block. That is, the down-sampled luma samples at the inner boundary of the collocated luma block of the current block will be included.

The total candidate types of the re-derived method (i.e., all the candidate types of re-derived methods) can be all or any subset/extension/combination of the above-mentioned candidate types.

After determining the type, for the determined type, multiple candidate models (i.e. cross-component models) are fixed (defined). The multiple candidate models are defined according to the implicit rules, and/or defined according to explicit signalling at the block, CU, SPS, PPS, picture, slice, tile, sequence, and/or CTU level. The determined type may correspond to one or more candidate models. In other words, after the type of re-derived method is determined, one or more models may be selected from the multiple candidate models. After selecting one or more models from the candidate models, the one or more selected models are used to generate one or more hypotheses of cross-component prediction, respectively. The final prediction of the current block will be formed using the one or more hypotheses of cross-component prediction. The final prediction of the current block may be the weight-averaged prediction of the motion compensated predictors, generated using motion vector information and/or block vector information, and the cross-component predictors generated based on the one or more hypotheses of cross-component prediction. The final prediction of the current block may be the weight-averaged prediction generated only based on the one or more hypotheses of cross-component prediction.

In one sub-embodiment, an explicit syntax element (e.g. a flag) is signalled to indicate the selected type. For example, the selected type corresponds to the case that the input reference samples (of the model derivation process for the re-derived method) are only (or mainly) from (within) the current block and/or the collocated luma block of the current block. For another example, the selected type corresponds to the case that the input reference samples (of the model derivation process for the re-derived method) are only (or mainly) from the neighbouring regions of the current block and/or of the collocated luma block of the current block. FIG. 9 illustrates an example according to the above embodiment, where a type flag for a current block using re-derived CCP mode is parsed in step 910. When the type is “current”, a corresponding index is parsed in step 920. Step 940 shows the multiple candidate models defined for the “current” type. The multiple candidate models are derived with input reference samples including only or mainly samples within the current block and/or within the collocated luma block of the current block. In step 950, one or more self-derived cross-component model are selected from the multiple candidate models illustrated in step 940. When the type is “neighbouring”, a corresponding index is parsed in step 930. Step 970 shows the multiple candidate models defined for the “neighbouring” type. The multiple candidate models are derived with input reference samples including samples that are located only or mainly at the neighbouring region of the current block and/or the collocated luma block of the current block. In step 960, one or more self-derived cross-component model are selected from the multiple candidate models illustrated in step 970.

For an example of the type being using the input reference samples of model derivation only (or mainly) from (i.e., within) the current block and/or the collocated luma block of the current block:
One candidate model is CCRM (with the filtering terms consisting of 6 spatial luma samples, a nonlinear term, and a bias term).
Other candidate models can have the unified filtering terms with all or any subset of available models from intra cross-component models. When doing model derivation (calculating values of the filter coefficients), the usage of input reference samples for the model derivation are only (or mainly) from the current block and/or the collocated luma block of the current block (following the determined type). That is, other candidate models may have the same filtering terms as some intra cross-component models, such as CCLM, CCCM, MMLM, GLM, MDF-CCCM. The filtering terms are derived only or mainly using the input reference samples within the current block and/or the collocated luma block of the current block, as enforced by the selected type of re-derived method.
The total candidate models here (i.e., all the defined candidate models) can be all or any subset/extension/combination of the above-mentioned candidate models.

For another example of the type being using the reference samples of model derivation only (or mainly) from the neighbouring regions of the current block and/or of the collocated luma block of the current block:
One or more candidate models can have the unified filtering terms with all or any subset of available models from intra cross-component models. When doing model derivation (calculating values of the filter coefficients), the usage of input reference samples of the model derivation is only (or mainly) from the neighbouring regions of the current block and/or of the collocated luma block of the current block (following the determined type). In other words, one or more candidate models may have the same filtering terms as some intra cross-component models, such as CCLM, CCCM, MMLM, GLM, MDF-CCCM. The filtering terms are derived only or mainly using the input reference samples from the neighbouring regions of the current block and/or of the collocated luma block of the current block, as enforced by the selected type of re-derived method.
The total candidate models here (i.e., all the defined candidate models) can be all or any subset/extension/combination of the above-mentioned candidate models.

In another sub-embodiment, in the case of the determined type containing only one model, the one model is used to generate one hypothesis of cross-component prediction.

In another sub-embodiment, in the case of the determined type containing multiple candidate models, one or more models are selected according to a pre-defined rule.

In one sub-embodiment, the multiple candidate models can be put into a list, which only includes re-derived models, following any pre-defined order. For example, the order is pre-defined as single CCCM, multiple CCCM, CCLM, and then MMLM.

In one sub-embodiment, the size of the list can be fixed at (i.e., pre-defined as) any positive integer or can be adaptively decided according to the availability checking of the candidate models.

In one sub-embodiment, the availability checking of single CCCM, multiple CCCM, CCLM, and MMLM is described as follows.

The availability of single-model CCCM and multi-model CCCM candidates depends on the model parameters of single-model CCCM. Only when any of the first six parameters of single-model CCCM for Cb or any of the first six parameters of single-model CCCM for Cr is non-zero, single-model and multi-model CCCM candidates are available in the CCP merge list.

Similarly, the availability of single-model CCLM and multi-model CCLM candidates depends on the scaling parameters of single-model CCLM. Only when the scaling parameter of single-model CCLM for Cb or the scaling parameter of single-model CCLM for Cr is non-zero, single-model and multi-model CCLM candidates are available in the CCP merge list.

In another sub-embodiment, the pre-defined rule is signalling one or more explicit index to select one or more model from the list.

The indices can be coded using variable length codes. In one example, the indices can be truncated unary coded. For example, the index with the shortest codeword refers to the model at the front of the list. The index with the longest codeword refers to the model at the end of the list.

For another example, a cost (e.g., a template cost) is calculated for each candidate in the list and the list is reordered according to the costs. The index with the shortest codeword refers to the model at the front of the list and with the smallest cost in the list. The index with the longest codeword refers to the model at the end of the list and with the largest cost in the list.

For another example, a cost (e.g. a template cost) is calculated for a subset of the candidates in the list, those candidates in the subset of the list are reordered according to the costs, and the remaining candidates in the list are not reordered. The index with the shortest codeword refers to the model at the front of the list. The index with the longest codeword refers to the model at the end of the list.

For another example, when calculating the costs, a preference setting can be used to adjust the costs. For another example, the preference setting corresponds to the case that for some preferred models (e.g., CCCM-related models or any preferring definition in any video coding standard), the costs can be reduced to make the preferred models have smaller costs.

In another sub-embodiment, the pre-defined rule is to implicitly select one or more models from the list. A cost (e.g., a template cost) is calculated for each candidate in the list. The one or more models with the smaller costs in the list are selected. When calculating the costs, a preference setting can be used to adjust the costs. For some preferred models (e.g., CCCM-related models or any preferring definition in any video coding standard), the costs can be reduced to make the preferred models have smaller costs.

In another sub-embodiment, when determining to use one (selected) type, one or more pre-defined models from the other (non-selected) type can still be used to generate one or more hypotheses of cross-component prediction and be combined with one or more hypotheses of cross-component prediction from the one or more selected models belonging to the selected type. For an example of the selected type indicating to use the reference samples of model derivation only (or mainly) from the neighbouring regions of the current block and/or of the collocated luma block of the current block, the pre-defined model from the other type can be CCRM and use CCRM to generate CCRM-prediction. The CCRM-prediction will be combined with the hypotheses of prediction from the selected models belonging to the type indicating to use the reference samples of model derivation only (or mainly) from the neighbouring regions of the current block and/or of the collocated luma block of the current block. When doing combination, the weighting can be fixed (e.g. equal weighting and/or any non-equal fixed numbers to preferring any pre-defined model) and/or the weighting can vary according to the implicit rule (e.g. costs of the models, stored model information of any pre-defined coded blocks, block width, block height, and/or block area) and/or the explicit rule (e.g. signalling information of the any pre-defined coded blocks and/or signalling syntax elements of the current block).

In another embodiment, a list which only contains re-derived models is built.

In one embodiment, the list contains several candidates using the input reference samples of model derivation only (or mainly) from the current block and/or the collocated luma block of the current block, and/or several candidates using the input reference samples of model derivation only (or mainly) from the neighbouring regions of the current block and/or of the collocated luma block of the current block.

In one sub-embodiment, all or any subset of the methods used for modelList can be applied here. For example, a cost for each candidate in the list is calculated. When calculating the costs, a preference setting can be used to adjust the costs. For some preferred models (e.g. CCCM-related models or any preferring definition in any video coding standard), the costs can be reduced to make the preferred models have smaller costs. One or more candidates with the smaller costs are selected implicitly or one or more explicit indices are signalled to indicate the selected one or more candidates from the cost-reordered list. After selecting one or more models from the candidate list, the one or more selected models are used to generate one or more hypotheses of cross-component prediction, respectively. The final prediction of the current block will be formed using the one or more hypotheses of cross-component prediction. The final prediction of the current block may be the weight-averaged prediction of the motion compensated predictors (using motion vector information and/or block vector information) and the cross-component predictors based on the one or more hypotheses of cross-component prediction. The final prediction of the current block may be the weight-averaged prediction only based on the one or more hypotheses of cross-component prediction. In one sub-embodiment, the CCRM-prediction will be combined with the hypotheses of prediction from the selected models belonging to using the reference samples of model derivation only (or mainly) from the neighbouring and/or the CCRM-prediction will be combined with the hypotheses of prediction from the selected models not belonging to CCRM.

In another embodiment, if a re-derived candidate model requires neighbouring samples to derived model, when the required neighbouring samples are not available or invalid to access, the re-derived candidate model is invalid, not added into the candidate list, or not allowed to be selected. For example, if a re-derived candidate model requires neighbouring samples to derived model, but the left and top neighbouring samples are outside the current picture/slice boundary, the re-derived candidate model is invalid, not added into the candidate list, or not allowed to be selected. For another example, if a re-derived candidate model requires neighbouring samples to derived model, but the neighbouring samples are outside the reference buffer or the neighbouring reconstruction buffer, the re-derived candidate model is invalid, not added into the candidate list, or not allowed to be selected. For another example, if a re-derived candidate model requires neighbouring samples to derived model, but the required neighbouring samples are not available or invalid to access, the re-derived candidate model is replaced by another candidate model.

In another embodiment, if the re-derived method is determined to be used, the first model type derived using the current reference samples and the second model type derived using the neighbouring reference samples are not the same. For example, the first model type and the second model type are single-model LM and multiple-model LM, or multiple-model LM and single-model LM. For another example, first model type and the second model type are 2-parameter LM model (e.g., model parameters are composed of a scaling parameter and an offset parameter) and convolutional LM model (e.g., CCCM, GL-CCCM, NS-CCCM, MDF-CCCM), or convolutional LM model and 2-parameter LM model.

In another embodiment, an implicit rule (not using the additional flag) is used to determine whether to use the re-derived model.

In another embodiment, if no model can be inherited during building the modelList, or the spatial adjacent/non-adjacent candidates, history candidates, temporal candidates, or all or any subset (e.g., before default candidates) of mentioned candidates in this invention are not available, use the re-derived model.

In another embodiment, when the proposed inherited method is used. The candidate with the smallest cost (e.g., the first candidate in the modelList) is implicitly selected to generate the cross-component prediction. For another example, an index is signalled to select one or more candidates from the modelList. More details can be found in Section II.

### V. Details of the Cross-Component Mode (Including Model Information) in the Candidate List

### V.1. Inheriting CCM Information

In one embodiment, the cross-component model (CCM) information of inherited cross-component model can be stored together with the inherited model parameters. The CCM information can be inherited together with the inherited model parameters. The prediction of the current block can be generated based on the inherited CCM information and inherited model parameters. The CCM information can include, but not limited to, prediction mode (e.g., CCLM, MMLM, CCCM, 2-parameter GLM, 3-parameter GLM (GLM model with luma term), model index for indicating which model shape is used in the convolutional model, classification threshold for multi-model, information to indicate that non-downsampled samples are used in the convolutional model, down-sampling filter flag (whether to do down-sampling), down-sampling filtering index when multiple down-sampling filters are used, number of neighbouring lines used to derive the model, types of templates used to derive model, post-filtering flag, and model parameters.

In one embodiment, a mixed CCCM model consisting of various terms (e.g., spatial term, gradient term, location term, non-linear term and bias term) can be inherited. In addition to storing model parameters, a prediction mode can be stored in the CCM information to indicate that the inherited model is a mixed CCCM model consisting of various terms. If there are multiple types of mixed CCCM models, a model index can also be stored in the CCM information to indicate which type of mixed CCCM model is inherited. For example, gradient and location based CCCM (GL-CCCM) proposed in JVET-AB0119 (Ramin G. Youvalari, et al., “Non-EE2: Gradient and location based convolutional cross-component model (GL-CCCM) for intra prediction”, Joint Video Exploration Team (JVET) of ITU-T SG 16 WP 3 and ISO/IEC JTC 1/SC 29/WG 11, 28th Meeting, Mainz, DE, 20-28 Oct. 2022, Document: JVET-AB0119) is a mixed CCCM model which consists of one spatial term in the centre position, two gradient terms for the horizontal direction and vertical direction, two location terms X and Y for the relative horizontal location and relative vertical location, one non-linear term and one bias term. A prediction mode can be stored in the CCM information to indicate that the inherited model is a GL-CCCM model.

### VI. Constructing a Candidate List

### VI.1. Reordering the Candidates in the List

The candidates in the list can be reordered to reduce the syntax overhead when signalling the selected candidate index or to bypass the syntax for signalling the selected candidate index by using implicit rule to select the one or more candidates.

In one embodiment, the reordering rules can depend on the coding information of neighbouring blocks or the model error. For example, if neighbouring above or left blocks are coded by MMLM, the MMLM candidates in the list can be moved to the head of the current list.

In one embodiment, the reordering rule is based on the model error by applying the candidate model to the neighbouring templates of the current block, and then compare the error with the reconstructed samples of the neighbouring template.

### VII. Self-Derived Cross-Component Model

In one embodiment, an example of the self-derived cross-component model is CCRM. When doing the self-derivation, the model (filtering shape/pattern, parameter terms) is unified with the cross-component models in regular intra mode. For example, CCRM model can be unified with any pre-defined existing intra cross-component model (e.g. CCCM using non-downsampled luma samples, GLM, MMLM) and/or the self-derivation only means the input of deriving model parameters is from the current chroma and collocated luma samples (for example, motion compensation results if the current block is inter).

In another embodiment, the self-derived cross-component candidate refers to one or more models and the models are used to generate the cross-component prediction of the current block as follows. The cross-component prediction (used for generating target predicted samples) of the current bock is formed by combining one or more proposed source terms and the models (referring to a proposed weighting setting). As shown in equation (3), pred (i, j) is a target (predicted) sample in the current block which can be obtained after our proposed mechanism, sourceTermSet0 includes one or more source terms from luma component, sourceTermSet1 includes one or more source terms from chroma components, and biasTermSet includes one or more bias terms.

Equation (3) is just an example and our proposed mechanism can use any subset or extension of sourceTermSet0, sourceTermSet1, and biasTermSet. Each sample or any subset of samples in the current block gets its target (predicted) sample according to the equation (3). In the following, the content of sourceTermSet0 is described in Section VII.1, “Content of sourceTermSet0(i, j)”, the content of sourceTermSet1 is described in Section VII.2, “Content of sourceTermSet1(i, j)”, the content of biasTermSet is described in Section VII.3, “Content of biasTermSet”, and the predictor derivation using the proposed source terms and the proposed weighting setting is described in Section VII.4, “Predictor derivation for sample (i, j)”. Several examples with our proposed mechanism are shown in Section VII.4, “Predictor derivation for sample (i, j)”. Several examples with our proposed mechanism are shown in Section VII.4.

$$pred ( i , j ) = ( sourceTermSet 0 ( i , j ) + sourceTermSet 1 ( i , j ) + … + biasTermSet ) with the proposed weighting setting where ( i , j ) is a sample position in the current block . \qquad ( 3 )$$

VII.1. Content of sourceTermSet0(i, j)

SourceTermSet0(i, j) includes one or more luma source terms denoted as sourceTerm00, sourceTerm01, . . . , and/or sourceTerm0n−1. The value of n means the number of taps for the source term set.

In one embodiment, the source terms can be linear terms and/or non-linear terms, only linear terms, and/or only non-linear terms.

In another embodiment, n is a pre-defined value, such as 1, 2, . . . or any positive integer. For example, the pre-defined value is fixed.

In another embodiment, n is determined by coding information of the current block and/or sample position (i, j). For example, when the current block is coded by a specific coding tool, n can be fixed at a pre-defined value for that specific coding tool.

In another embodiment, the pattern of the n taps refers to a pattern defined as any subset of a window region M×N around/including the position (iL, jL) as shown in FIG. 10A. If the target sample is luma, (iL,jL) is (i, j). If the target sample is chroma (e.g., Cb or Cr), (iL, jL) is the collocated luma position from (i, j).

For one example, only the centre (iL,jL) of the window is used as shown in FIG. 10A.

For another example of the pattern being 5×5 cross including or not excluding (iL,jL) as shown in FIG. 10B.

For a source term in the source term set, the following embodiments are used to determine generation of the source content.

In one embodiment, the source content is based on a predicted sample generated by a prediction mode and/or a reconstructed sample generated based on the predicted sample by a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples. If the target sample (i, j) belongs to chroma and gradient information of the collocated luma sample (as the centre circle) is calculated with any one of the following Sobel filters (1110-1140) in FIG. 11 or any pre-defined filter. Each value around the centre circle is multiplied with the corresponding predicted/reconstructed samples in the collocated luma block and then added with each other to form the gradient information for the source term of the target sample (i, j).

In another sub-embodiment, since the target sample belongs to a chroma sample (e.g., Cb or Cr)), the predicted sample and/or the reconstructed sample is located within the collocated (luma) block from the current (chroma) block. The predicted sample and/or the reconstructed sample is treated as an initial sample and used as source content to generate the target sample.

In another embodiment, the source term may further include location information. For example, if the target sample refers to luma, the horizontal location (i) of (i, j) is used in a source term and the vertical location (j) of (i, j) is used in a source term; otherwise, the horizontal location of the collocated luma block from the sample (i, j) is used in a source term and the vertical location of the collocated luma block from the sample (i, j) is used in a source term.

In another embodiment, the source term may further include location information. For example, if the target sample refers to chroma, the horizontal location of the collocated luma from the sample (i, j) is used in a source term, and the vertical location of the collocated luma from the sample (i, j) is used in a source term.

VII.2. Content of sourceTermSet1(i, j)

SourceTermSet1(i, j) includes one or more chroma (Cb or Cr) source terms denoted as source Term00, sourceTerm01, . . . , and/or sourceTerm0m−1. The value of m means the number of taps for the source term set. In one embodiment, the source terms can be linear terms and/or non-linear terms, only linear terms, and/or only non-linear terms. In another embodiment, m is a pre-defined value such as 1, 2, . . . or any positive integer. For example, the pre-defined value is fixed.

In another embodiment, m is determined according to coding information of the current block and/or sample position (i, j). For example, when the current block is coded by a specific coding tool, m is fixed at a pre-defined value for that specific tool.

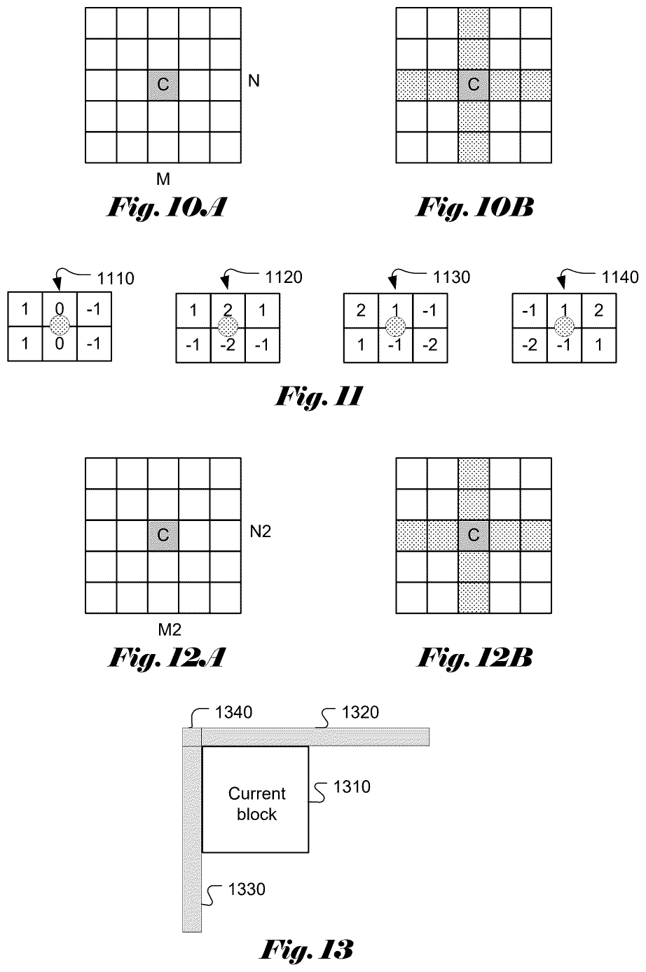

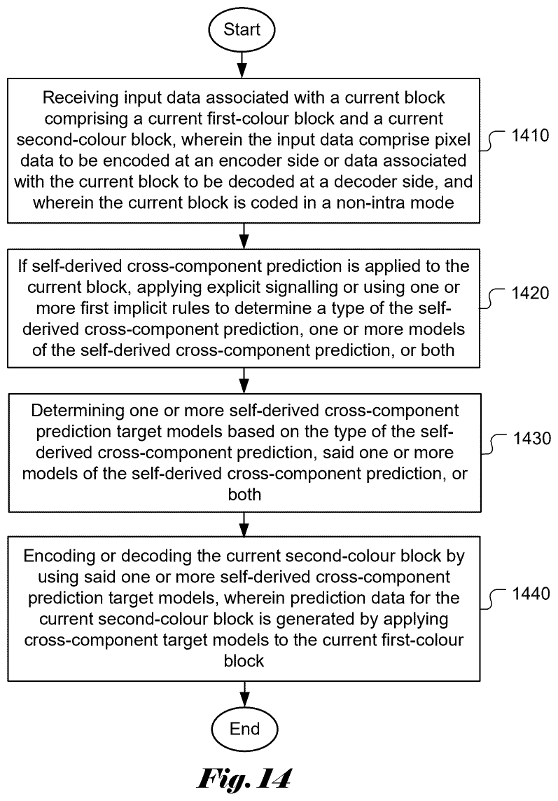

In another embodiment, the pattern of the m taps refers to a pattern defined as any subset of an M2×N2 window region around/including the position (iC, jC) as shown in FIG. 12A. If the target sample is chroma (Cb or Cr), (iC,jC) is (i, j). If the target sample is luma, (iC, jC) is the collocated chroma position from (i, j).

For one example, only the centre (iC,jC) of the window is used as shown in FIG. 12A.

For another example of the pattern being 5×5 cross: (including or not excluding (iC,jC)) as shown in FIG. 12B.

For a source term in the source term set, the following embodiments are used to determine generation of the source content.

In one embodiment, the source content is based on a predicted sample generated by a prediction mode and/or a reconstructed sample generated based on the predicted sample based on a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples. If the target sample (i, j) belongs to luma, gradient information of the collocated chroma sample is calculated with any one of the Sobel filters or any pre-defined filter.

In another sub-embodiment, if the target sample belongs to a chroma sample, the predicted sample and/or the reconstructed sample is located within the current block. The predicted sample and/or the reconstructed sample is treated as an initial sample and used as the source content to generate the target sample.

In another embodiment, the source term may further include location information. For example, if the target sample refers to chroma, the horizontal location (i) of (i, j) is used in a source term and the vertical location (j) of (i, j) is used in a source term.

VII.3. Content of biasTermSet

Bias term is a pre-defined value. In one embodiment, the bias term is a midValue according to bitDepth. For example, the bias term is set as (1<<(bitDepth−1)). In another embodiment, the bias term is the same for each sample in the current block. That is, the bias term is independent of the position (i, j).

### VII.4. Predictor Derivation for Sample (i, j)

### VII.4.1. Proposed Weighting Setting

The proposed weighting setting is to estimate the relationship (e.g. minimizing the distortion) between “the predicted and/or reconstructed samples on the reference region of the current (chroma) block” and “the predicted and/or reconstructed samples on the reference region of the corresponding luma block” by a pre-defined regression method, and to generate a weighting (referring to model parameters) according to the regression method. The weighting derived is then applied on the source terms to get the target (predicted) samples in the current block. In one embodiment, the pre-defined regression method can be linear minimum mean square error (LMMSE) method for CCLM or can be any unified method with the regression method used for CCLM. In another embodiment, the pre-defined regression method can be the LDL decomposition method for CCCM or can be any unified method with the regression method used for CCCM. In another embodiment, the pre-defined regression method can be Gaussian elimination.

In one embodiment, the reference region of the current block is the spatial neighbouring region of the current block 1310 as shown in FIG. 13. The spatial neighbouring region of the current block includes above reference region 1320, left reference region 1330, above-left reference region 1340, and/or any subset of the above. The size of the above reference region is A_{W}×A_{H}, the size of the left reference region is L_{w}×L_{H}, and the size of the above-left reference is AL_{W}×AL_{H}, where
A_{W}=block width of the current block (W), k*W, W+block height of the current block (H), any pre-defined value, or any adaptive value depending on the block position, block width, block height, and/or block area of the current block.
A_{H} or AL_{H}=H, any pre-defined value (1, 2, 4, . . . ), or any adaptive value depending on the block position, block width, block height, and/or block area of the current block.
L_{W} or AL_{W}=W, any pre-defined value (1, 2, 4, . . . ), or any adaptive value depending on the block position, block width, block height, and/or block area of the current block.
L_{H}=H, k*H, H+W, any pre-defined value, or any adaptive value depending on the block position, block width, block height, and/or block area of the current block.

The reference region of the corresponding luma block is the spatial neighbouring region of the corresponding luma block.

In another embodiment, the reference region of the current block is the vector-collocated region of the current block and the reference region of the corresponding luma block is the vector-collocated region of the corresponding luma block. For inter coding unit containing luma and chroma blocks, the vector-collocated region of the current block refers to the motion compensated results obtained by using the motion information (motion vectors and reference pictures) of the current block, and the vector-collocated region of the corresponding luma block refers to the motion compensated results obtained by using the motion information (motion vectors and reference pictures) of the corresponding luma block. For IBC or intraTMP, the vector-collocated region of the current block refers to the motion compensated results obtained by using the motion information (e.g. block vectors and current picture) of the current block, and the vector-collocated region of the corresponding luma block refers to the motion compensated results obtained by using the motion information (e.g. block vectors and current picture) of the corresponding luma block.

In another embodiment, the above-proposed two kinds of the reference region of the current block can be used together. For example, generally, samples in the vector-collocated region of the current block are used as input samples during deriving model parameters; however, for a smaller block, samples in the spatial neighbouring reference region are used as additional input samples when deriving model parameters.

The term “block” in this invention can refer to TU/TB, CU/CB, PU/PB, or CTU/CTB.

The term “LM” in this invention can be viewed as one kind of CCLM/MMLM modes or any other extension/variation of CCLM (e.g. the proposed CCLM extension/variation in this invention). One variation is MMLM which uses thresholds to decide different models for different samples in the current chroma component. Another variation is that for Cb (or Cr), deriving model parameters from multiple collocated luma blocks. The following show more possible variations. The variations of CCLM here mean that some optional modes can be selected when the block indication refers to using one of cross-component modes (e.g. CCLM_LT, MMLM_LT, CCLM_L, CCLM_T, MMLM_L, MMLM_T, and/or an intra prediction mode, which is not one of traditional DC, planar, and angular modes) for the current block. The following shows an example of using the convolutional cross-component mode (CCCM) as an optional mode. When this optional mode is applied to the current block, cross-component information with a model, including non-linear term, is used to generate the chroma prediction. The optional mode may follow the template selection of CCLM, so CCCM family includes CCCM_LT CCCM_L, and/or CCCM_T.

The proposed methods (for CCLM) in this invention can be used for any other cross-component modes.

Any combination of the proposed methods in this invention can be applied.

Any of the foregoing proposed methods of cross-component prediction by using self-derived cross-component prediction candidates based on the type of the self-derived cross-component prediction, models of the self-derived cross-component prediction, or both can be implemented in encoders and/or decoders. For example, any of the proposed methods can be implemented in an inter, intra, prediction, IBC, transform, quantization module or a combination of them at an encoder side, and/or an inter, intra/prediction, IBC, transform, quantization module or a combination of them at a decoder side. Alternatively, any of the proposed methods can be implemented as a circuit coupled to the inter, intra, prediction, transform, quantization module or a combination of them at the encoder and/or the inter, intra, prediction, IBC, transform, quantization module of the decoder, so as to provide the information needed by the inter/intra/prediction/IBC/transform/quantization module.

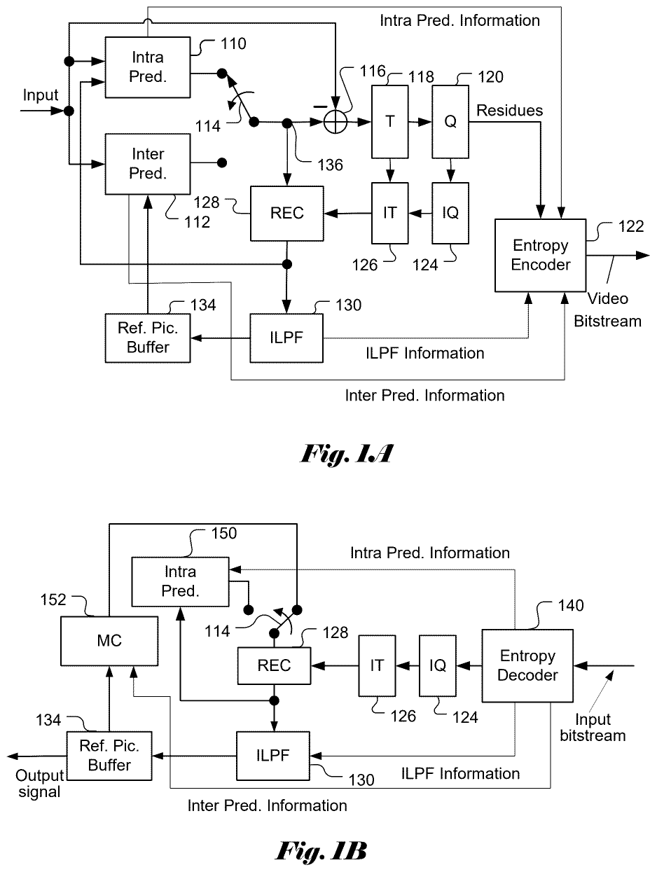

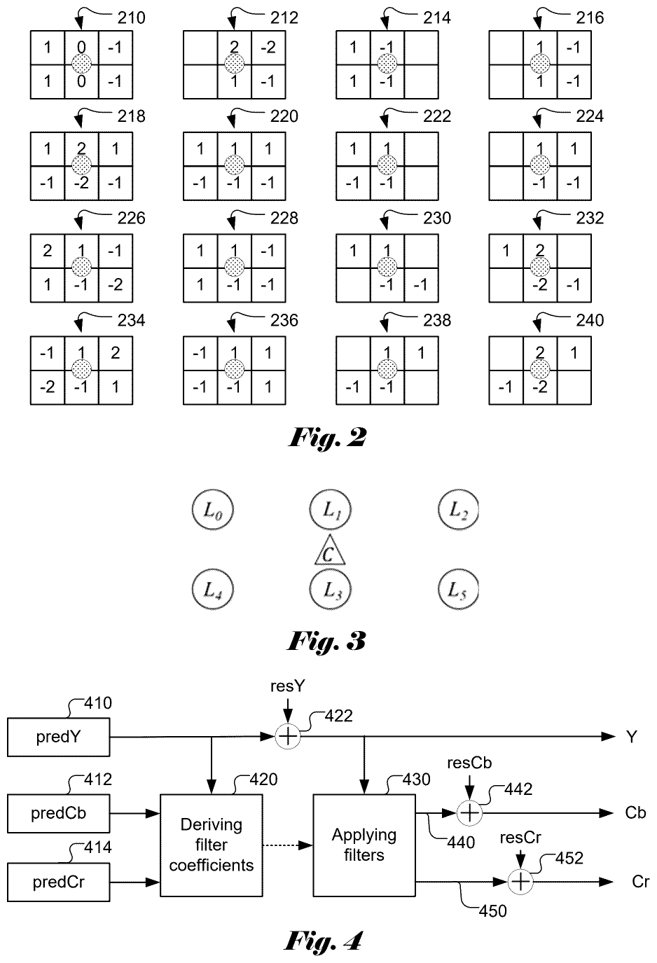

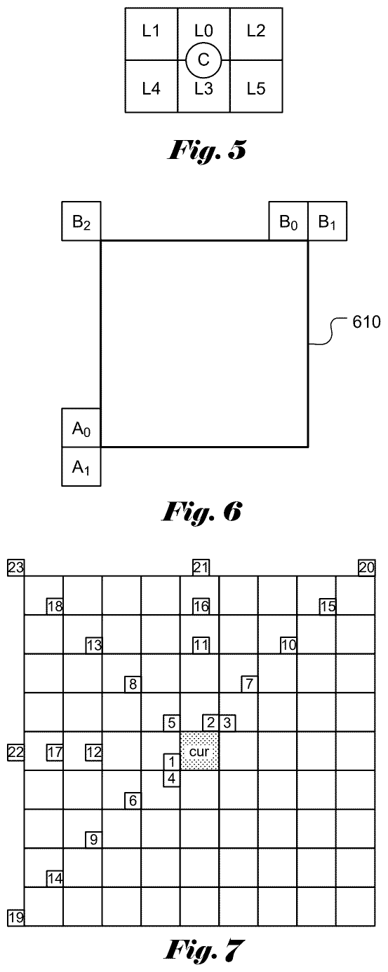

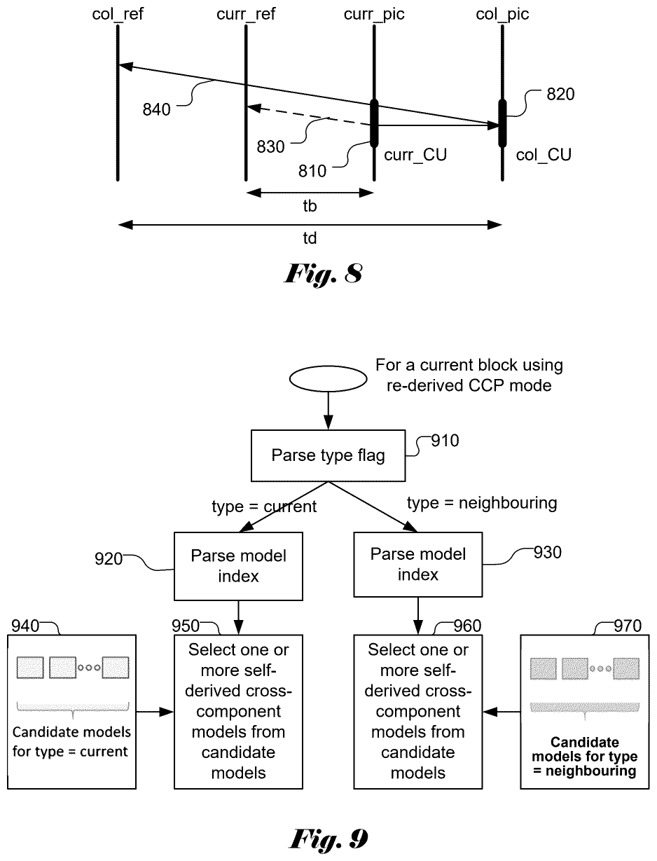

The method of using self-derived cross-component prediction candidates based on the type of the self-derived cross-component prediction, models of the self-derived cross-component prediction, or both as described above can be implemented in an encoder side or a decoder side. For example, any of the proposed method can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed propagated cross-component prediction can also be implemented as a circuit coupled to the intra/inter coding module at the decoder or the encoder. However, the decoder or encoder may also use additional processing unit to implement the propagated cross-component prediction processing. While the Intra Pred./MC units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 14 illustrates a flowchart of an exemplary video coding system that uses self-derived cross-component prediction candidates based on the type of the self-derived cross-component prediction, models of the self-derived cross-component prediction, or both according to an embodiment of the present invention. The steps shown in the flowchart may be implemented as program codes executable on one or more processors (e.g., one or more CPUs) at the encoder or decoder side. The steps shown in the flowchart may also be implemented based hardware such as one or more electronic devices or processors arranged to perform the steps in the flowchart. According to this method, input data associated with a current block comprising a current first-colour block and a current second-colour block is received in step 1410, wherein the input data comprise pixel data to be encoded at an encoder side or data associated with the current block to be decoded at a decoder side, and wherein the current block is coded in a non-intra mode. If self-derived cross-component prediction is applied to the current block, explicit signalling is applied or one or more implicit rules are used in step 1420 to determine a type of the self-derived cross-component prediction, one or more models of the self-derived cross-component prediction, or both. One or more self-derived cross-component prediction target models are determined in step 1430 based on the type of the self-derived cross-component prediction, said one or more models of the self-derived cross-component prediction, or both. The current second-colour block is encoded or decoded by using the said one or more self-derived cross-component prediction target models in step 1440, wherein when a target cross-component prediction candidate is selected to code the current second-colour block, prediction data for the current second-colour block is generated by applying a corresponding cross-component model to the current first-colour block.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a current first-colour block and a current second-colour block, wherein the input data comprise pixel data to be encoded at an encoder side or data associated with the current block to be decoded at a decoder side, and wherein the current block is coded in a non-intra mode;
if self-derived cross-component prediction is applied to the current block, applying explicit signalling or using one or more first implicit rules to determine a type of the self-derived cross-component prediction, one or more models of the self-derived cross-component prediction, or both;
determining one or more self-derived cross-component prediction target models based on the type of the self-derived cross-component prediction, said one or more models of the self-derived cross-component prediction, or both; and
encoding or decoding the current second-colour block by using said one or more self-derived cross-component prediction target models, wherein prediction data for the current second-colour block is generated by applying cross-component target models to the current first-colour block.

2. The method of claim 1, wherein for the type of the self-derived cross-component prediction, said one or more models of the self-derived cross-component prediction are identified.

3. The method of claim 2, wherein said one or more models of the self-derived cross-component prediction are identified according to one or more second implicit rules, or according to explicit signalling at a block level, CU level, SPS level, PPS level, picture level, slice level, tile level, sequence level, CTU level, or a combination thereof.

4. The method of claim 1, wherein said one or more self-derived cross-component prediction target models are used to generate one or more hypotheses of cross-component prediction and a cross-component predictor is generated based on said one or more hypotheses of cross-component prediction.

5. The method of claim 1, wherein after the type of the self-derived cross-component prediction is determined, said one or more self-derived cross-component prediction target models are selected from said one or more models of the self-derived cross-component prediction.

6. The method of claim 1, wherein one type of the self-derived cross-component prediction refers to deriving said one or more models of the self-derived cross-component prediction based on input reference samples including only neighbouring samples of the current block, neighbouring samples of a collocated luma block of the current block, or both.

7. The method of claim 6, wherein samples within the current block, the collocated luma block of the current block, or both are not referenced.

8. The method of claim 6, wherein the input reference samples include only neighbouring samples of the current block, the neighbouring samples of the collocated luma block of the current block, or both with one or more exceptions.

9. The method of claim 8, wherein type of self-derived cross-component prediction selected corresponds to using input reference samples only or mainly from neighbouring regions of the current block, from neighbouring regions of the collocated luma block of the current block, or both.

10. The method of claim 6, wherein said one or more models of the self-derived cross-component prediction have filtering terms the same as some intra cross-component models, and wherein the filtering terms are derived only or mainly using the input reference samples from neighbouring regions of the current block, from neighbouring regions of the collocated luma block of the current block, or both.

11. The method of claim 1, wherein one type of the self-derived cross-component prediction refers to deriving said one or more models of the self-derived cross-component prediction based on input reference samples including only samples within the current block, a collocated luma block of the current block, or both, including only samples within the current block, the collocated luma block of the current block, or both with one or more exceptions.

12. The method of claim 11, wherein type of self-derived cross-component prediction selected corresponds to using input reference samples only or mainly within the current block, the collocated luma block of the current block, or both.

13. The method of claim 11, wherein said one or more models of the self-derived cross-component prediction have filtering terms the same as some intra cross-component models, and wherein the filtering terms are derived only or mainly using the input reference samples within the current block, the collocated luma block of the current block, or both.

14. The method of claim 11, wherein said one or more models of the self-derived cross-component prediction comprise CCRM (Cross-Component Residual Model).

15. The method of claim 1, wherein a flag is signalled or parsed to indicate the type of the self-derived cross-component prediction.

16. The method of claim 1, wherein for the type of the self-derived cross-component prediction determined, if multiple models of the self-derived cross-component prediction are defined, the multiple models of the self-derived cross-component prediction are inserted into a candidate list following a pre-defined order and the candidate list includes only self-derived models, or one or more models are selected from the multiple models of the self-derived cross-component prediction as said one or more self-derived cross-component prediction target models according to a pre-defined rule.

17. The method of claim 16, wherein a size of the candidate list is pre-defined as any positive integer or adaptively decided according to availability of the multiple models of the self-derived cross-component prediction.

18. The method of claim 17, wherein availability of single-model CCCM and multi-model CCCM candidate models are dependent on model parameters or scaling parameters of single-model CCCM.

19. The method of claim 16, wherein the pre-defined rule corresponds to implicitly selecting said one or more models as said one or more self-derived cross-component prediction target models from the candidate list, or the pre-defined rule corresponds to signalling one or more explicit indices to select said one or more models as said one or more self-derived cross-component prediction target models from the candidate list.

20. The method of claim 19, wherein a cost is calculated for each candidate model in the candidate list and one or more candidate models with smallest costs in the candidate list are selected.

21. An apparatus for coding colour pictures or video using coding tools including one or more cross component models related modes, the apparatus comprising one or more electronic circuits or processors arranged to:
receive input data associated with a current block comprising a current first-colour block and a current second-colour block, wherein the input data comprise pixel data to be encoded at an encoder side or data associated with the current block to be decoded at a decoder side, and wherein the current block is coded in a non-intra mode;
if self-derived cross-component prediction is applied to the current block, apply explicit signalling or use one or more first implicit rules to determine a type of the self-derived cross-component prediction, one or more models of the self-derived cross-component prediction, or both;
determine one or more self-derived cross-component prediction target models based on the type of the self-derived cross-component prediction, said one or more models of the self-derived cross-component prediction, or both; and
encode or decode the current second-colour block by using said one or more self-derived cross-component prediction target models, wherein when a target cross-component prediction candidate is selected to code the current second-colour block, prediction data for the current second-colour block is generated by applying a corresponding cross-component model to the current first-colour block.
